(19) United States
(12) Patent Application Publication
(10) Pub. No.: US 2008/0121092 A1
(43) Pub. Date: May 29, 2008

(54) Digital media DJ mixer

(75) Inventors: Leonid Drel, Brooklyn, NY (US); Mark Matthews, Bayonne, NJ (US); Mikhail Kupriyanov, St-Petersburg (RU); Alexander Pisarevsky, St-Petersburg (RU); Denis Serebryansky, St-Petersburg (RU); Dmitry Bondar, St-Petersburg (RU)

Correspondence Address: HOFFMANN & BARON, LLP, 6900 JERICHO TURNPIKE, SYOSSET, NY, 11791, US

(73) Assignee: GCI Technologies Corp.

(21) Appl. No.: 11/521,832

(22) Filed: Sep. 15, 2006

(51) Int. Cl. G10H 7/00

(52) U.S. Cl. 84/612

(57) ABSTRACT

The present invention provides a music playback and manipulation system for generating audio playback of digital musical comprising; a user control device having an external memory interface for providing access to random access memory and read only memory, a mass storage host controller for providing access to and control of data from, a user controller interface and an audio subsystem interface; a mass storage device for storing a plurality of audio files; and a user control device for varying playback parameters of said audio files.

### FIELD OF THE INVENTION

This invention relates to a device for playing digital audio files wherein the user can dynamically manipulate and control playback parameters of the audio files by the operation of controls devices incorporated into the playback device.

### BACKGROUND OF THE INVENTION

In common use for DJs today, are the CD Player and the Turntable. They act as control interfaces, through which the DJ matches the speed of one record or CD on one control interface to the speed of a record or CD on the other control interface, and then seamlessly mixes one to the other in order to make them seem like one song. The purpose of this is to keep the beat going in dance clubs so people can continue dancing even though the song changes. A device called a “mixer” does the actual mixing from one interface to the other.

With the maturation of digital music files in the market, individuals are increasingly in need of a way to play and manipulate these files on their DJ equipment. Since most turntables are strictly analog devices, CD players have been the only way to do this. Given this, CD players started implementing added functionality to support MPG CD's, which were simply data CD's with digital music files on them. When a DJ would insert an MP3 CD into supporting CD Players, you could browse through the contents using a text readout that pulls from the ID3 Tag data in each digital file.

However, this technology still utilizes the compact disc, which are limited to storing only a few songs each. Therefore, a DJ must transport many CD's whenever the need a large selection of music arises. The DJ market is in need of a solution similar to MP3 players that are capable of holding a large amount of data and thus house a large music collection.

There is currently available a device known as the Numark HDCD1, which comes equipped with a 40 Gig internal hard drive as well as dual CD decks. This product has the ability to read CD's, take data from the CD and copy it to the internal hard drive, and load music data files from a computer. However, it does not have the ability to take advantage of external USB devices such as USB Flash Drives, MP3 Players, and other similar storage devices.

Therefore there is a need for a digital audio file playback device that can utilize digital music files contained on at least one portable mass storage device that also provides for user control in real time of audio playback parameters.

### SUMMARY OF THE INVENTION

Applicant has overcome the shortcomings of prior art methods with the present invention by providing a digital audio filed playback device that can access music and audio files from mass storage devices connected via a USB host controller. The mass storage device can be in the form of an MP3 player such as an iPod™, or other such well known devices. The device of the present invention also provides the user with the ability to control audio playback parameters by utilizing a buffer memory for seamlessly controlling and manipulating audio files during real time playback so that a user may add various playback effects typically used by music DJ's.

In accordance with the present invention, a user, such as a DJ has the ability to connect any external USB device to the unit, and utilize the library of digital music files stored inside. The user can browse through the library by song name, artist, or genre. Furthermore, the user can during playback of an audio file, manipulate its pitch (speed of playback) for the purpose of mixing, as well as an array of other functions comparable to what current DJ technology will allow users to do to CDs and Records, such as for example sampling, hot cueing, key lock, and master tempo features.

The fundamental technology that will set this unit apart from the prior art is the fact that it can take advantage of one storage device via multiple controllers, which is currently not available in prior art products on the market. This is done via a specific process that utilizes buffer memory. The controller unit will sample data packets of the song a few at a time, and load directly into the Random Access Memory(RAM) on the controller. Once brought into the RAM, the data packets are decoded and send directly to the DAC for audible output. At the end of each packet, the unit takes the succeeding packet from the storage device and repeats this seamless and inaudible process.

The present invention dual units will allow DJs to utilize this feature set between the two decks provided. The single tabletop units will come standard with slave outputs that will allow for the linking between paired units, so they both can take advantage of the single connected device. Supported USB devices include flash drives, external hard drives, and USB compatible MPG Players such as the Apple® iPod®.

The present invention therefore provides improved convenience for DJs because instead of carrying a big bag of records or CDs, they only need to carry a single storage device, which will be smaller in size, lighter in weight, and hold much more music. Given the reliance on external devices, the controller in accordance with the current invention will be much more conveniently sized than its modern day counterparts, such as the CD player and the turntable.

The present invention therefore provides a digital music playback and manipulation system for generating audio playback of digital musical comprising; a user control device having an external memory interface for providing access to random access memory and read only memory, a mass storage host controller for providing access to and control of data from, a user controller interface and an audio subsystem interface; a mass storage device for storing a plurality of audio files; and a user control device for varying playback parameters of said audio files.

### BRIEF DESCRIPTION OF THE DRAWINGS

FIG. 1 is a block diagram depicting the device according to the present invention.

FIG. 2 is a block diagram depicting the hardware connection diagram according to the present invention.

FIG. 3 is a block diagram depicting the software connection diagram according to the present invention.

### DETAILED DESCRIPTION OF THE PREFERRED EMBODIMENTS:

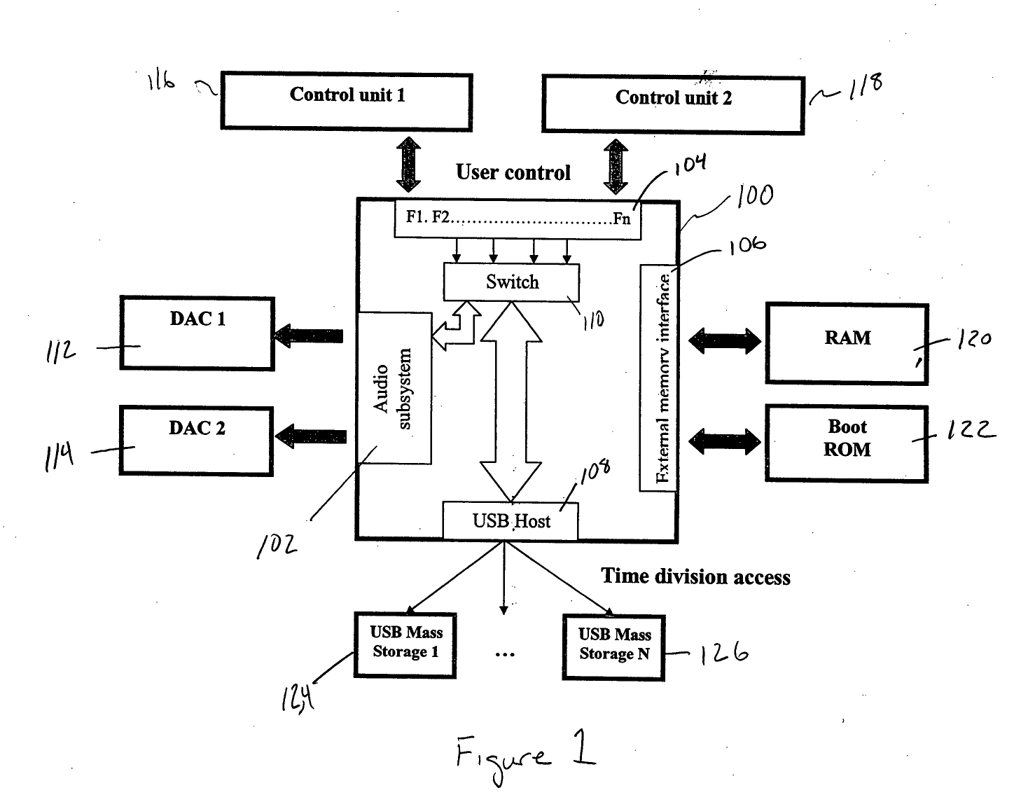

Turning now to FIG. 1, there is shown a block diagram of the playback device according to the present invention. There is shown a central playback unit 100, which includes various subsystems. Those subsystems include an audio subsystem, a user control input connector 104, an external memory interface 106, a USB host controller 108, and a switch 110. The audio subsystem includes inputs from digital to analog converters (DAC) 112 and 114. In this depicted embodiment there are two DAC's shown, however any number of converters are possible within the scope of the present invention. The User Control input connector provides a plurality of connectors for linking the playback unit 100 to Control unit 1, 116 and Control unit 2, 118. The control units provide a user with control elements, such as buttons, thumb wheels, turntable platters and the like to vary audio playback parameters.

The control unit provides functionality to allow intuitive, simple operation of the system and interaction with various parameters with a minimum number of buttons, while at the same time preserving the power of the system. For example the control unit can provide buttons that enable a user to directly access, or initiation, modes of operation of the system. The different controls that can be provided may include a Joystick to enable the user to select or interact with various musical or system parameters or the like. A save/edit key may be provided to save songs or parameter changes, etc., that a user may have created or made using the system, and also to initiate editing of parameters, Play lists, samples, etc. Volume controls may also be provided, in any number of configurations, such as dual button up/down form or a single knob or dial to enable the output volume level to be adjusted. Function keys may also be provided to enable player functions such as play, stop, forward, reverse, and record. Other control elements, such as buttons or wheels, may be provided to enable a user to easily and intuitively adjust one or more audio effects (e.g., doppler, reverb, wobbler, custom, etc.) of a part of music being played (e.g., a particular sample sound). A Pitch/tempo control may also be provided to enable single button activation for pitch/tempo changes.

Turning again to FIG. 1, there is also shown an expanded memory interface 106, which provides a memory connection socket for adding both random access memory RAM 120 and boot read only memory (boot ROM) 122. The interface may be a typical memory card connector such as a pin/socket, beam on blade, elastomeric or surface mount for use with portable memory media such as a PC Card, ExpressCard, Miniature Card, Smart Media Card, or Multimedia Card interface. It should be noted that the above listed alternates are meant to be exemplary. Other alternate memory card connectors and memory card media are possible within the scope of this invention.

Turning again to FIG. 1, there is also depicted in the playback device 100 a USB host controller 108. The USB host controller provides connectivity for a plurality of USB mass storage devices, depicted here as USB Mass Storage 1 124, through USB Mass Storage N 126. USB host controller 108 may be implemented in a combination of hardware, firmware, or software as is known in the art. Typical USB mass storage devices may include a compact disk-read only memory (CD-ROM), digital video disk-read only memory drive (DVD-ROM) drive or other dedicated mass storage devices such as MP3 audio players, such as for example the popular iPod® device.

The playback device further includes a switch 110 for providing the user with the ability to dynamically select between various audio files connected to the playback unit 100 through the USB host 108 and further to control the playback parameters of a selected audio file by utilizing the control features of one of the control units 116, 118. It should be noted that by providing for a plurality of control units and audio file mass storage units, the user is provided with the capability to dynamically and seamlessly switch between audio files during the transition from one song to another. In addition, because there are at least two control units, the user can control more that one audio file concurrently. This can be especially useful when the user is playing an ongoing sequence of songs for example. In this case, the user can utilize a second controller to cue up a second audio file, while a first audio file is playing.

The switch of the playback device is therefore connected to the audio subsystems 102, in order that an audio file, once selected by the user, can be sent to the through the audio subsystems 102 in accordance with the playback parameters selected by the user through a control unit 116/118. A DAC, 112/114 will then convert the digital audio file into an analog audio signal for playback using typical audio equipment, (not shown) such as an amplifier and speakers.

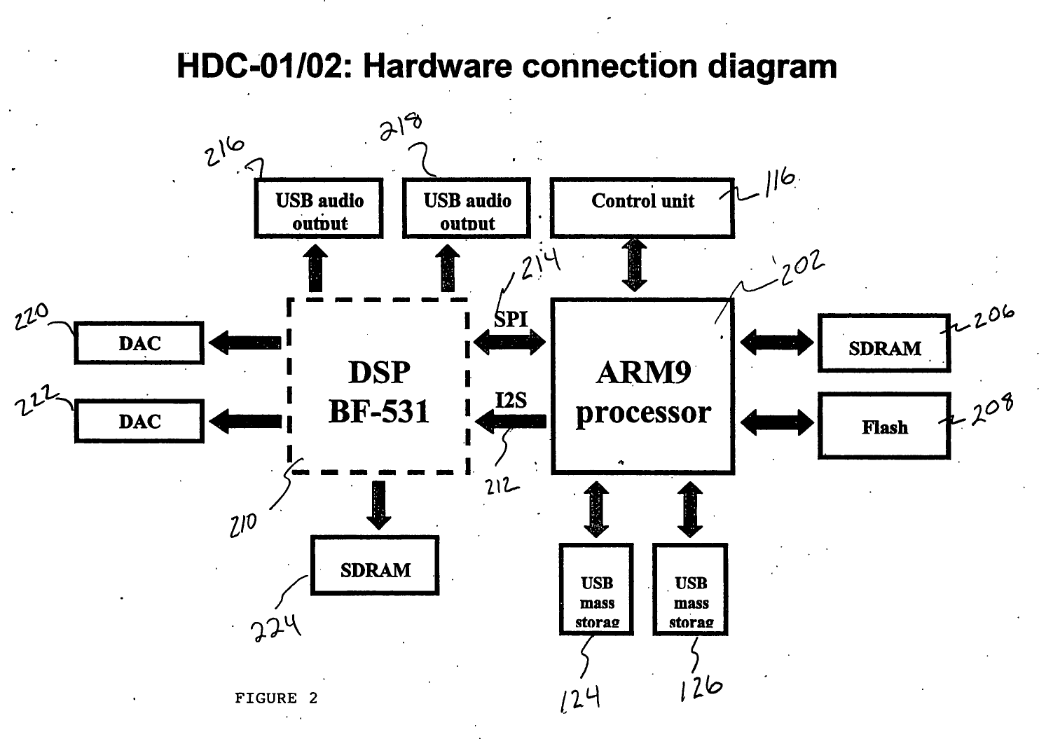

Turning now to FIG. 2, there is shown a block diagram of the hardware connections according to the present invention. The playback device 100 of the present invention includes a microprocessor 202. The system architecture of preferred embodiments includes a microprocessor or microcontroller for controlling the overall system operation. The microprocessor 202 may selectively be any general-purpose microprocessor such as an Intel XXX86, Motorola 68XXX or other equivalent microprocessor capable of executing instructions. In this exemplary embodiment, the processor may be an ARM microprocessor such as an ARM 9 microprocessor. As will be further explained hereinafter, the microprocessor 202 typically receives user instructions and data obtained from the control units 116/118, memory 120/122 and USB mass storage 124/126, associates it with a playback function or parameter chosen by the user on the playback device 100 and outputs to the digital signal processor 210 via inter IC sound bus.212 Inter-IC Sound [12S] is a serial bus designed for digital audio devices, which handles audio data separately from clock signals. It should be noted that in the embodiment depicted the digital signal processor (DSP) is depicted as an processor manufactured by Analog Devices and sold under the model number BF-531. However, other DSP's may be utilized which meet the required specifications for computational demands and power constraints for a full 32-bit RISC MCU programming model device according to the present invention for real time signal processing. Additionally the digital signal processor 210 and the processor 202 are linked via a serial peripheral interface SPI 214 The SPI bus is a synchronous serial interface for connecting processor 210 and the processor 202. The control information, such as for example the characteristics of effect parameters, buffer sizes, instructions, and etc. from processor 202 is transmitted to signal processor 210 via the SPI bus.

Turning again to FIG. 2, there is shown a first 216 USB audio output and a second 218 USB audio output. While the depicted embodiment is limited to having two USB audio outputs, it should be apparent to one skilled in the art that any number of USB audio outputs may be incorporated into the present design without departing from the spirit of the present invention.

Furthermore, in electrical communication with the DSP 210, there is depicted a first digital to analog converter (DAC) 220 and a second DAC 222. The DAC 220 and 222 receive streaming digital media files, in this case music files and convert the digital media signal to an analog signal such as a line level audio signal that can then be then transmitted to an amplifier, amplified and then output through speakers. As in the case of the USB audio outputs 216 and 218, while there are only two DAC's shown in the depicted embodiment, it should be apparent to one skilled in the art that any number of DAC's may be incorporated into the present design without departing from the spirit of the present invention. The DSP is also in further communication with a synchronous dynamic random access memory SDRAM module 224. SDRAM is a type of dynamic random access memory that can run at much higher clock speeds than conventional memory since SDRAM can actually synchronizes itself with the CPU's bus speed. The SDRAM 224 provides a dynamic memory storage medium 224 for keeping the tables for the effect implementations, audio buffers, and the temporary info for calculations.

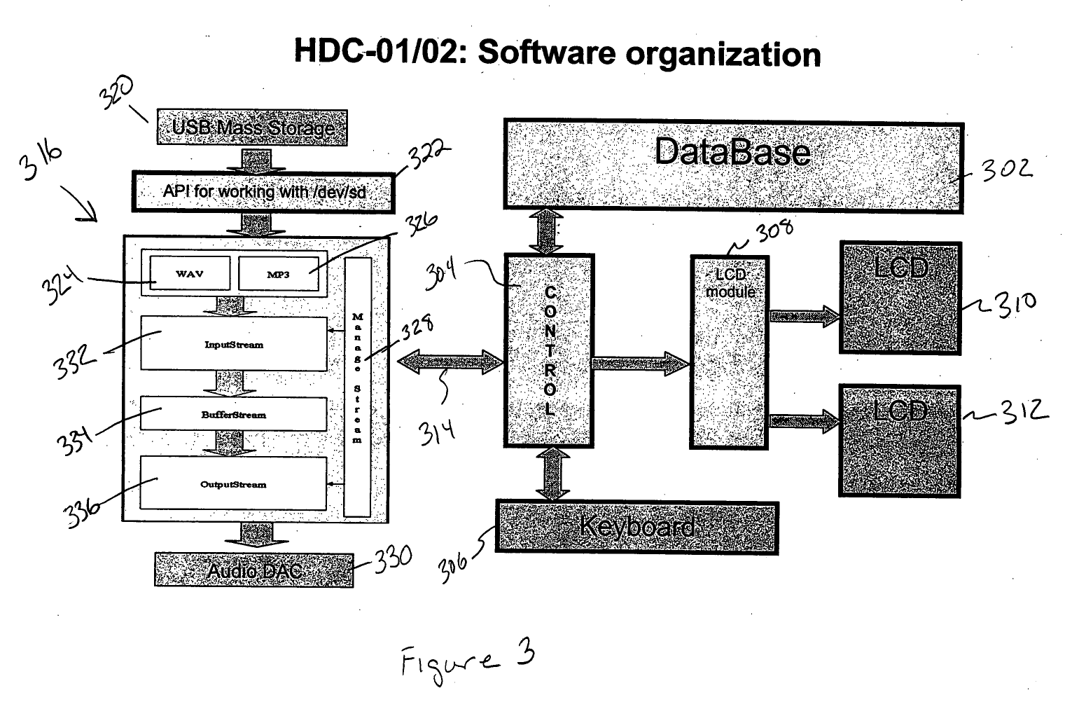

Turning now to FIG. 3, there is shown a software organization chart in accordance with the present invention. FIG. 3 shows a software organization block diagram. The software of the present invention includes a database 302 which provides a storage repository for the hardware operating system. The database is connected to the control module 302 which provides software control of playback parameters of a selected audio file. Additionally the software control module 302 includes control instructions for input and output devices such as a keyboard 306 and a display device such as a LCD 310 and 312 which are controlled by an LCD module 308, although other types of display devices are possible within the scope of this invention.

Turning again to FIG. 3, there is shown and interface 314 between the control module 304 and the audio playback portion of the software. The audio playback portion includes a USB enabled mass storage device 320 which contains audio data files such as for example compressed mp3's, mpeg's, Ogg Vorbis or other type of audio files. It should further be noted that the audio files need not be compressed but may instead be uncompressed files stored in a mass storage device 320. The data contained on the USB mass storage device 320 is transferred to the audio playback device via an application program interface (API) 322, which is optimized for dev/sd wherein /dev/sd refers to any particular playback device that can be connected to the unit, like CD-ROM, DVD-ROM, and etc.

The API 322 provides the interface for transferring the data, such as audio music files from the storage device to the audio playback device 316. The audio data can be for example a wav file 324 or mp3 file 326, although it need not be so limited as other types of audio files compression techniques may be utilized within the scope of this invention. The audio files are then sent as a data stream to the output audio digital to analog converter (DAC) 330. The data stream is managed by the software 328 which controls the input stream 332, the buffer stream 334 and the output stream 336. The input stream is made up of the audio file, which is then buffered, or saved within the buffer stream 334 in such as way as to enable the smooth playback of music and audio files while the user is manipulating various playback parameters, within the scope of this invention. The buffer stream 334 is then transferred to the output stream 336 with the altered playback parameters and then the digital audio output stream 336 is transferred to the audio DAC 330 where it is converted to an analog audio signal that can be amplified and played through speaker for listeners.

This is done via a specific process that utilizes buffer memory. The controller unit will sample data packets of the song a few at a time, and load directly into the Random Access Memory(RAM) 120 on the controller. Once brought into the RAM, the data packets are decoded and send directly to the DAC 112/114 for audible output. At the end of each packet, the unit takes the succeeding packet from the storage device and repeats this seamless and inaudible process.

It will be appreciated that the present invention has been described herein with reference to certain preferred or exemplary embodiments. The preferred or exemplary embodiments described herein may be modified, changed, added to or deviated from without departing from the intent, spirit and scope of the present invention. It is intended that all such additions, modifications, amendments, and/or deviations be included within the scope of the claims appended hereto.

1. An audio playback and manipulation system for generating sound from digital audio files comprising:
a central playback unit having an a computer processor, a software controlled switch, and an external memory interface for providing access to random access memory and read only memory;
a mass storage host controller for providing access to and control of data from at least one mass storage device wherein each mass storage device contains a plurality of audio files;
at least two user controller interfaces, where each interface is coupled to a user control device for controlling the playback parameters of the audio files; and
an audio subsystem interface and at least one digital to analog converter, for converting the audio files into sound;
wherein the at least two user control devices can simultaneously control a plurality of audio files stored on the at least one mass storage device, and output a manipulated audio data stream to the audio subsystem.

2. (canceled)

3. An audio playback and manipulation system as in claim 1 wherein each mass storage device is selected from an mp3 player, an external hard disk drive, a device comprising flash memory, a CD-ROM, and a DVD-ROM.

4. An audio playback and manipulation system as in claim 1 wherein the mass storage host controller is a USB host controller, and each mass storage device is connected to the central playback unit through a USB interface.

5. An audio playback and manipulation system as in claim 1, wherein the playback parameters controlled for a plurality of audio files simultaneously are selected from stopping, reversing, fading, varying the pitch, varying the tempo, varying the reverb, varying the Doppler and varying the wobble of the audio output.

6-21. (canceled)

22. An audio playback and manipulation system as in claim 1 wherein each mass storage device is connected to the central playback unit through a serial interface.

23. An audio playback and manipulation system as in claim 1 further comprising software comprising a database and instruction set, and capable of decoding user input from the user control devices and controlling the playback parameters of a plurality of audio files simultaneously.
